(19) United States
(12) Patent Application Publication
(10) Pub. No.: US 2005/0135763 A1
(43) Pub. Date: Jun. 23, 2005

(54) Optical fiber with a mechanically strippable coating and methods of making the same

(76) Inventors: Gary Drenzek, Westfield, MA (US); David Bolte, Brimfield, MA (US)

Correspondence Address: GOODWIN PROCTER LLP;PATENT ADMINISTRATOR, 53 STATE PLACE, BOSTON, MA, 02109-2881, US

(21) Appl. No.: 10/738,069

(22) Filed: Dec. 17, 2003

(51) Int. Cl. G02B 6/22

(52) U.S. Cl. 385/128

(57) ABSTRACT

A mechanically strippable optical fiber includes a layer of low-adhesion material disposed between a glass fiber and a polymeric outer coating of high thermal stability. The layer low-adhesion material renders the coating amenable to mechanical stripping without damaging the glass fiber. Methods for producing mechanically strippable optical fibers with thermally stable outer coatings are also provided.

### FIELD OF THE INVENTION

This invention relates to the field of optical fibers, more particularly to optical fibers with mechanically strippable coatings.

### BACKGROUND

Optical fibers are widely used in modern optical devices and data communication systems. Optical fibers generally comprise a glass fiber surrounded by one or more layers of a coating material, such as a polymer or a plastic (e.g., acrylate-based polymers rated at temperatures up to 85° C.). Optical fibers used in high temperature applications must be coated with a material that can withstand prolonged exposure to heat. Polyimide is an example of a coating material suitable for optical fibers for use at high temperatures (e.g., in the range of 400° C.).

Before an optical fiber can be spliced or otherwise incorporated into a fiber optic component, such as a ferrule or a fiber coupler, it may be necessary to remove at least a portion of its outer coating. Current methods for removing coatings include thermal, chemical, and mechanical stripping. These methods, however, suffer from several drawbacks. Thermal stripping processes use heat to remove the coating. Removal of thermally-stable outer coatings can require temperatures as high as 800° C. As a result, thermal stripping can deposit carbon and/or oxidizing agents from the heat source onto the fiber, which may adversely affect the performance of the fiber. Moreover, remnants of the coating can remain attached to the glass fiber after heating, which can reduce the tensile strength and performance characteristics of the fiber.

Chemical stripping processes use solvents and/or concentrated acid or base solutions to remove the coating. Acid stripping is often performed using hot sulfuric or nitric acid solutions. Storing, handling, and transporting the chemicals used in this process pose a significant operating inconvenience and health hazard to operators. Some coatings may not dissolve cleanly, or may form degradation products that adhere to the glass fiber and are difficult to remove. In order to remove any acid residue left on the glass fiber, the stripped fiber often must be washed with one or more rinse solvents, making the process more costly and time consuming.

Mechanical stripping processes use a stripping tool to cut through the layers of coating materials and scrape the coating off the end of an optical fiber. Existing thermally-stable outer coatings, such as polyimide, for example, are difficult to strip using mechanical stripping tools due to the adhesion of the coating to the glass fiber. The force required to remove the outer coating may, for example, cause the glass fiber to break or crack.

There is therefore a need for an optical fiber having an outer coating of high thermal stability that can be mechanically stripped without damaging the glass fiber.

### SUMMARY OF THE INVENTION

The present invention provides a mechanically strippable optical fiber that includes at least one layer of low-adhesion material disposed between a glass fiber and at least one outer coating having a high thermal stability. This approach facilitates ready removal of the outer coating without sacrificing the protection against heat that it confers. The low-adhesion material can be a fluorinated polymer, such as polytetrafluoroethylene (PTFE), perfluoroalkoxy (PFA), fluorinated ethylene propylene (FEP), ethylene tetrafluoroethylene (ETFE), polytetrafluoroethylene perfluoromethylvinylether (MFA), or tetrafluoroethylene hexafluoropropylene vinylidene (THV), for example. Alternatively, the low-adhesion material can be polypropylene or polyethylene, or a silicone-based material. The low adhesion layer can have a thickness ranging from about 1 μm to about 50 μm, and preferably from about 2 μm to about 10 μm.

The outer coating can comprise a polymer (for example, a polyimide) or a metal (for example, aluminum, gold, nickel, tin, or alloys thereof) that exhibits high thermal stability, i.e., which is capable of withstanding temperatures of 300° C. or above, and preferably temperatures of 400° C. or above. In some embodiments, all or a portion of the low-adhesion layer can be removed along with the outer coating.

The invention also provides a method for producing a mechanically strippable optical fiber that includes a glass fiber, at least one layer of low-adhesion material, and at least one outer coating having a high thermal stability. The low-adhesion material can be dissolved or suspended in a solvent (e.g., as a monomer or prepolymer) prior to application to the glass fiber, and then heated to cure the low-adhesion layer. Alternatively, the low-adhesion layer can be applied in a molten state or by a dip-coating process. The outer coating can be dissolved or suspended in a solvent prior to application over the low-adhesion layer, and then heated to cure the outer coating. The outer coating can also be applied by dip-coating.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a cross-sectional view of an optical fiber according to an embodiment of the invention.

FIG. 2 is a side view of the optical fiber of FIG. 1.

### DETAILED DESCRIPTION

The present invention provides a mechanically strippable optical fiber with one or more outer coatings having high thermal stabilities. Specifically, one or more layers of low-adhesion material are disposed between the glass fiber and the one or more outer coatings, which render(s) the outer coatings amenable to mechanical stripping without damaging the glass fiber. The present invention also provides methods for producing mechanically strippable optical fibers having outer coatings with high thermal stabilities.

1. Mechanically Strippable Coated Optical Fiber

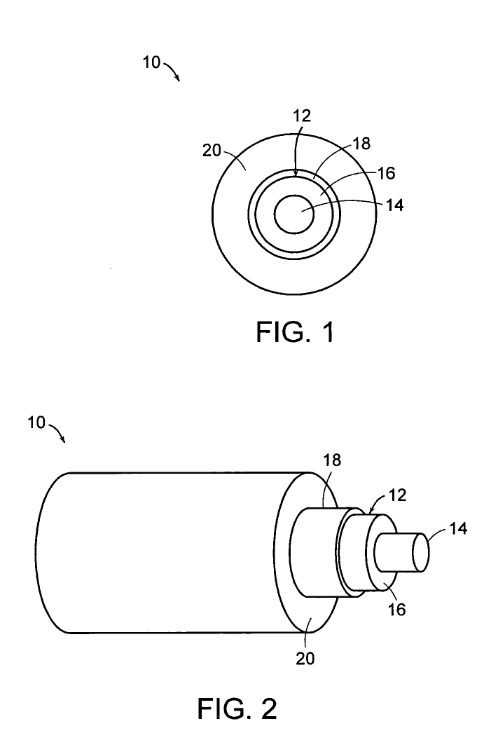

FIGS. 1 and 2 illustrate an optical fiber according to the present invention. The optical fiber 10 includes a glass fiber 12, which typically comprises a core 14 and a cladding 16. In some cases, the glass fiber comprises only a core 14. Disposed over the glass fiber is at least one layer of low-adhesion material 18, and at least one outer coating 20. FIGS. 1 and 2 illustrate an optical fiber that contains only a single low-adhesion layer and a single outer coating. However, optical fibers according to the invention may contain more than one low-adhesion layer and more than one outer coating.

In the illustrated embodiment, the glass fiber 12 is typically made of silica-based glass that can be doped with other materials to modify its refractive index. The core 14 of glass fiber 12 is the region where light is substantially confined during its propagation along the length of the optical fiber 10. The cladding 16 completely surrounds the core 14, acting to direct the path of the light along the core 14 and prevent light from leaking out of the core 14.

The low-adhesion layer 18 facilitates mechanical stripping of the outer coating 20 by allowing relative motion between the outer coating 20 and the glass fiber 12 upon application of a suitable stripping force; that is, the material exhibits low adhesion at least with respect to the glass fiber 12, and typically (although not necessarily) also with respect to the outer coating 20. However, the low-adhesion layer 18 should exhibit sufficient adhesion to the outer coating 20 and the glass fiber 12 such that the outer coating 20 stays in place and does not become delaminated from the glass fiber 12 during normal use. Suitable materials for a low-adhesion layer 18 include fluorinated polymers, such as PTFE, PFA, FEP, ETFE, MFA, and/or THV, for example. Polypropylene and low or high molecular weight polyethylene can also be used in a low-adhesion layer 18.

Other suitable materials for a low-adhesion layer 18 include polyorganosiloxane compounds, or “silicones.” Silicone compounds are based on the repeating diorganosiloxane unit (R₂SiO)ₙ where R is hydrogen or an organic radical and n denotes the number of units in the polymer chain. Each end of the liner chain is terminated with a functional or non-functional end group, and the chain may be “branched” so as to deviate from a strictly linear structure. Common silicone compounds are based on the polydimethylsiloxane unit, Si(CH₃)₂O, although any silicone compound can be used in a low-adhesion layer according to the invention.

The low-adhesion layer 18 is thin relative to the outer coating 20. In one embodiment, the low-adhesion layer ranges in thickness from about 1 μm to about 50 μm, and preferably from about 2 μm to about 10 μm. The relatively thin layer of low-adhesion material allows for sufficient interaction between portions of the outer coating 20 and portions of the glass fiber 12 to hold the outer coating 20 in place. Too thin a layer of low-adhesion material can allow for excessive mechanical interaction between the outer coating 20 and the glass fiber 12, making stripping difficult or impossible. On the other hand, an excessively thick layer of low-adhesion material may allow the outer coating 20 to slide relative to the glass fiber 12 during normal handling and use.

The outer coating 20 serves to protect the glass fiber 12 from damage and to preserve its tensile strength. The outer coating 20 is typically made from a material that is resistant to air and water. Outer coatings for optical fibers used in high temperature applications should also be able to withstand prolonged exposure to heat. Suitable materials for an outer coating 20 having a high thermal stability include polymers, such as polyimide polymers, fluorinated polymers (e.g., PFA and/or FEP), phenolic polymers, and polyetheretherketone (PEEK). The outer coating 20 can also consist of or include a metal, such as aluminum, gold, nickel, tin, or alloys thereof. In a preferred embodiment, the outer coating 20 includes a polyimide polymer. The polyimide may be unmodified, modified, or a combination. In unmodified polyimides, the imide is the principal functional group in the polymer, while modified polyimides include other functional groups. Examples of modified polyimide polymers include poly(amide-imide)s, polyesterimides, polyetherimides, and polybismaleimides. Preferred polyimides for use in the outer coating 20 are aromatic polymers based on biphenyldianhydride/1,4-phenylenediamine, or benzophenone tetracarboxylic dianhydride/4,4-oxydianiline/m-phenylenediamine. The outer coating 20 can include other additives, such as photoinitiators, antioxidants, and adhesion promoters, for example.

2. Making an Optical Fiber

The manufacture of glass fibers is well known in the art. In general, glass fibers are drawn from glass preform rods, which can be manufactured using a variety of processes, including modified chemical vapor deposition, vapor-phase axial deposition, and outside vapor deposition, for example. The preform is fed into a furnace at a controlled rate, and the glass fiber is drawn from the molten end of the preform. Single mode glass fibers, which transmit only one ray of light, have a small core diameter (<10 μm), while multimode fibers tend to have larger cores that can guide many light rays simultaneously.

The low-adhesion layer is applied to the glass fiber after it has been drawn from the preform. The low adhesion layer can be applied using any method known in the art, such as by spraying, deposition (e.g., by a vacuum process such as sputtering), pulling the fiber through a pool of liquid, passing the fiber over a moistened wick, and pulling the fiber through a coating die, for example. The low-adhesion material can also be melted, applied to the fiber in a molten state, and allowed to solidify or cure. In preferred embodiments, monomers that make up the low-adhesion material are dissolved or suspended in a solvent, and the fiber is coated with the solution by moving the fiber through a coating die (i.e., dip-coating). After the solution or suspension is applied to the fiber, the layer is heat cured in order to cross-link the monomers to form the low-adhesion layer and to evaporate the solvent.

After the low-adhesion layer has dried or cured, one or more outer coatings are applied. Any of the techniques described above can also be used to apply the outer coatings. In a preferred embodiment, an outer coating is applied by moving the fiber through a coating die followed by heat curing.

3. Stripping an Optical Fiber

An optical fiber according to the invention can be stripped using any mechanical stripping method known in the art. In one embodiment, one or more stripper blades are used to penetrate all or a portion of the thickness of the outer coating. The stripper blades are then moved in a direction parallel to the longitudinal axis of the optical fiber. The layer of low-adhesion material enables the severed section of the outer coating to slide cleanly and easily off of the glass fiber, without damaging the fiber and without leaving any remnants of the coating material on the stripped section of the fiber. In some embodiments, all or a portion of the low-adhesion layer is removed along with the outer coating during the stripping process.

Optical fibers according to the invention can be used to make a multi-fiber cable, an optical fiber ribbon, or any other construction containing a plurality of optical fibers held together in a polymer matrix. Any number of optical fibers assembled be used to form a fiber array of any shape, such as a coplanar parallel array, for example. A portion of each individual optical fiber is stripped and attached to a connector, which can then be connected to a sensing device or data communication system, for example, a device adapted for use in harsh environments.

### EQUIVALENTS

The invention may be embodied in other specific forms without departing form the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

1. An optical fiber, comprising:
a glass fiber;
an outer coating having a high thermal stability; and
a layer of low-adhesion material disposed between the fiber and the outer coating to facilitate stripping of the outer coating.

2. The optical fiber of claim 1, wherein the low-adhesion material comprises a fluorinated polymer.

3. The optical fiber of claim 2, wherein the fluorinated polymer comprises at least one member of the group consisting of polytetrafluoroethylene, perfluoroalkoxy, fluorinated ethylene propylene, ethylene tetrafluoroethylene, polytetrafluoroethylene perfluoromethylvinylether, and tetrafluoroethylene hexafluoropropylene vinylidene.

4. The optical fiber of claim 1, wherein the low-adhesion material is selected from the group consisting of polypropylene and polyethylene.

5. The optical fiber of claim 1, wherein the low-adhesion material comprises a silicone-based material.

6. The optical fiber of claim 1, wherein the layer of low-adhesion material has a thickness of about 1 μm to about 50 μm.

7. The optical fiber of claim 6, wherein the layer of low-adhesion material has a thickness of about 2 μm to about 10 μm.

8. The optical fiber of claim 1, wherein the outer coating is stable at or above 300° C.

9. The optical fiber of claim 1, wherein the outer coating is stable at or above 400° C.

10. The optical fiber of claim 1, wherein the outer coating comprises a polymer.

11. The optical fiber of claim 10, wherein the polymer comprises a polyimide polymer.

12. The optical fiber of claim 1, wherein the outer coating comprises a metal.

13. The optical fiber of claim 12, wherein the metal is selected from the group consisting of aluminum, gold, nickel, tin, and alloys thereof.

14. The optical fiber of claim 1, wherein the low-adhesion layer is removable together with the outer coating.

15. A method of forming an optical fiber, the method comprising the steps of:
applying a layer of low-adhesion material onto a glass fiber; and
applying an outer coating having a high thermal stability over the low-adhesion material, the low-adhesion material facilitating stripping of the outer coating.

16. The method of claim 15, wherein the low-adhesion material comprises a fluorinated polymer.

17. The method of claim 16, wherein the fluorinated polymer comprises at least one member of the group consisting of polytetrafluoroethylene, perfluoroalkoxy, fluorinated ethylene propylene, ethylene tetrafluoroethylene, polytetrafluoroethylene perfluoromethylvinylether, and tetrafluoroethylene hexafluoropropylene vinylidene.

18. The method of claim 15, wherein the low-adhesion material is selected from the group consisting of polypropylene and polyethylene.

19. The method of claim 15, wherein the low-adhesion material comprises a silicone-based material.

20. The method of claim 15, wherein the layer of low-adhesion material has a thickness of about 1 μm to about 50 μm.

21. The method of claim 20, wherein the layer of low-adhesion material has a thickness of about 2 μm to about 10 μm.

22. The method of claim 15, wherein the outer coating is stable at or above 300° C.

23. The method of claim 15, wherein the outer coating is stable at or above 400° C.

24. The method of claim 15, wherein the outer coating comprises a polymer.

25. The method of claim 24, wherein the polymer comprises a polyimide polymer.

26. The method of claim 15, wherein the outer coating comprises a metal.

27. The method of claim 26, wherein the metal is selected from the group consisting of aluminum, gold, nickel, tin, and alloys thereof.

28. The method of claim 15, wherein the low-adhesion layer is removable together with the outer coating.

29. The method of claim 15, wherein the low-adhesion material is dissolved or suspended in a solvent before applying it to the glass fiber.

30. The method of claim 29, further comprising the step of heat curing the layer of low-adhesion material after the step of applying the low-adhesion material to the glass fiber.

31. The method of claim 15, wherein the low-adhesion material is applied to the glass fiber in a molten state.

32. The method of claim 15, wherein the low-adhesion material is applied by dip-coating.

33. The method of claim 15, wherein the outer coating is dissolved or suspended in a solvent before applying it over the layer of low-adhesion material.

34. The method of claim 33, further comprising the step of heat curing the outer coating after the step of applying the outer coating over the low-adhesion material.

35. The method of claim 15, wherein the outer coating is applied by dip-coating.
